(19) United States
(12) Patent Application Publication
(10) Pub. No.: US 2026/0361091 A1
(43) Pub. Date: Nov. 12, 2026

(54) FLEXIBLE DIRECT-CURRENT FAULT RIDE-THROUGH CONTROL METHOD AND APPARATUS, STORAGE MEDIUM AND DEVICE

(71) Applicant: ELECTRIC POWER RESEARCH INSTITUTE, CHINA SOUTHERN POWER GRID, Guangzhou, Guangdong (CN)

(72) Inventors: Wangqianyun TANG, Guangzhou, Guangdong (CN); Xipeng CAI, Guangzhou, Guangdong (CN); Baorong ZHOU, Guangzhou, Guangdong (CN); Ye ZHANG, Guangzhou, Guangdong (CN); Wenfeng YAO, Guangzhou, Guangdong (CN); Ziqian YANG, Guangzhou, Guangdong (CN); Chao FU, Guangzhou, Guangdong (CN); Junjie LI, Guangzhou, Guangdong (CN); Hao YUAN, Guangzhou, Guangdong (CN); Shiyang LI, Guangzhou, Guangdong (CN); Zhifei GUO, Guangzhou, Guangdong (CN); Baoye TIAN, Guangzhou, Guangdong (CN); Dongqi HUANG, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 18/996,975

(22) PCT Filed: Dec. 19, 2023
(86) PCT No.: PCT/CN2023/139809

§ 371 Date: Jan. 17, 2025

(30) Foreign Application Priority Data
Jun. 29, 2023 (CN) 202310789851.8

(51) Int. Cl. H02M 1/32; H02M 3/155

(52) U.S. Cl. CPC H02M 1/32; H02M 3/155

(57) ABSTRACT

A flexible direct-current fault ride-through control method and apparatus, a storage medium, and a device, which relate to the technical field of power system control. The method comprises: acquiring an alternating-current side terminal voltage of a converter valve and an externally transmitted power of a flexible direct-current converter station; if the alternating-current side terminal voltage is lower than a low-voltage ride-through threshold, triggering low-voltage ride-through, and acquiring an active power instruction value during a fault period; determining a second integrator coefficient during the fault period according to the difference between the active power instruction value and the externally transmitted power; switching an integrator coefficient of a voltage outer-loop controller from a pre-fault first integrator coefficient to the second integrator coefficient; the difference between the active power instruction value during the fault period and the externally transmitted power having a negative correlation relationship with the second integrator coefficient; acquiring an alternating-current side terminal voltage in real time; and if the real-time value of the alternating-current side terminal voltage is higher than the low-voltage ride-through threshold, executing fault recovery, and switching the integrator coefficient of the voltage outer-loop controller to the first integrator coefficient. The present application can improve the stability of an isolated island system that transmits new energy by means of flexible direct current.

The present application claims priority to Chinese Patent Application No. 202310789851.8, titled “FLEXIBLE DIRECT-CURRENT FAULT RIDE-THROUGH CONTROL METHOD AND APPARATUS, STORAGE MEDIUM AND DEVICE”, filed on Jun. 29, 2023 with the China National Intellectual Property Administration, which is incorporated herein by reference in its entirety.

### FIELD

The present disclosure relates to the technical field of power system control, and in particular to a method and an apparatus for controlling voltage source converter-high voltage direct current fault ride-through, a storage medium and a computer device.

### BACKGROUND

It is a major strategic demand for power system construction at present to accelerate construction of large-scale wind power photovoltaic bases focusing on areas including desert, Gobi and barren land. The large-scale pure renewable energy base is of a large installed capacity and a wide distribution area, and generally adopts a voltage source converter-high voltage direct current islanded transmission mode. The conventional fault ride-through strategy in a voltage source converter-high voltage direct current VF control (fixed alternating-current voltage/fixed frequency control) mode generally used for an offshore wind power transmission system. A large-scale pure renewable energy base transmission system has a relatively high probability of fault and requires a relatively high stability of the transmitting end system after a fault.

In order to ensure transient stability of the transmitting end of the large-scale pure renewable energy base, the renewable energy at the transmitting end actively reduces the power during a fault period and slows down rate of recovering the power. In the conventional technology, the input of outer loop controller of voltage source converter-high voltage direct current is set to zero to prevent the integral controller from saturation during the fault period, causing that no power supply provided in the large-scale pure renewable energy base transmitting end system to regulate the voltage during the transient process. Therefore, the large-scale pure renewable energy base transmitting end system may face the problems of voltage stability after a fault occurs. In a case that a conventional controlled outer-loop controller is adopted, upon a relatively severe fault occurring, the excessively large deviation and excessively rapid action of the outer loop may cause problems in transient stability.

### SUMMARY

A method and an apparatus for controlling voltage source converter-high voltage direct current fault ride-through, a storage medium and a device are provided according to embodiments of the present disclosure, to improve the stability of a pure renewable energy islanded transmission system via voltage source converter-high voltage direct current.

In a first aspect, a method for controlling voltage source converter-high voltage direct current fault ride-through is provided according to the present disclosure. The method is applied to a voltage source converter-high voltage direct current conversion station in a pure renewable energy islanded transmission system via voltage source converter-high voltage direct current. The method includes:
acquiring an alternating-current side voltage of a conversion valve and a transmitted power of the voltage source converter-high voltage direct current conversion station;
triggering low voltage ride-through and acquiring an active power instruction value corresponding to a fault period if the alternating-current side voltage is less than a low voltage ride-through threshold;
determining a second integral coefficient corresponding to the fault period based on a difference between the active power instruction value and the transmitted power;
switching an integral coefficient of a voltage outer-loop controller from a first integral coefficient before the fault to the second integral coefficient, where the first integral coefficient is greater than the second integral coefficient, and the difference between the active power instruction value corresponding to the fault period and the transmitted power is negatively correlated with the second integral coefficient;
acquiring the alternating-current side voltage in a real time manner; and
performing fault recovery and switching the integral coefficient of the voltage outer-loop controller to the first integral coefficient, if the real-time value of the alternating-current side voltage is greater than the low voltage ride-through threshold.

In an embodiment, the acquiring an active power instruction value corresponding to a fault period includes:
acquiring the transmitted powers of the voltage source converter-high voltage direct current conversion station within a preset time period before the triggering low voltage ride-through;
calculating an average value of the transmitted powers of the voltage source converter-high voltage direct current conversion station within the preset time period; and
determining the average value as the active power instruction value corresponding to the fault period.

In an embodiment, the preset time period is greater than or equal to 60 s.

In an embodiment, during the low voltage ride-through, the method further includes:
acquiring the transmitted power of the voltage source converter-high voltage direct current conversion station in a real time manner; and
dynamically regulating the second integral coefficient based on the real-time value of the transmitted power of the voltage source converter-high voltage direct current conversion station.

In an embodiment, during the low voltage ride-through, and after the determining a first integral coefficient based on a difference between the active power instruction value and the transmitted power, the method further includes:
calculating a second proportion coefficient corresponding to the fault period based on the first integral coefficient, the second integral coefficient and a first proportion coefficient of the voltage outer-loop controller before the fault; and
switching a proportion coefficient of the voltage outer-loop controller from the first proportion coefficient to the second proportion coefficient, and switching the proportion coefficient to the first proportion coefficient when the fault recovery is implemented.

In a second aspect, an apparatus for controlling voltage source converter-high voltage direct current fault ride-through is provided according to the present disclosure. The apparatus is applied to a voltage source converter-high voltage direct current conversion station of a pure renewable energy islanded transmission system via voltage source converter-high voltage direct current. The apparatus includes a first acquisition module, a low voltage ride-through module, a first determination module, a first switching module, a second acquisition module and a fault recovery module.

The first acquisition module is configured to acquire an alternating-current side voltage of a conversion valve and a transmitted power of the voltage source converter-high voltage direct current conversion station.

The low voltage ride-through module is configured to trigger low voltage ride-through and acquire an active power instruction value corresponding to a fault period if the alternating-current side voltage is less than a low voltage ride-through threshold.

The first determination module is configured to determine a second integral coefficient corresponding to the fault period based on a difference between the active power instruction value and the transmitted power.

The first switching module is configured to switch an integral coefficient of a voltage outer-loop controller from a first integral coefficient before the fault to the second integral coefficient. The first integral coefficient is greater than the second integral coefficient, and the difference between the active power instruction value corresponding to the fault period and the transmitted power is negatively correlated with the second integral coefficient.

The second acquisition module is configured to acquire the alternating-current side voltage in a real time manner.

The fault recovery module is configured to perform fault recovery and switch the integral coefficient of the voltage outer-loop controller to the first integral coefficient, if the real-time value of the alternating-current side voltage is greater than the low voltage ride-through threshold.

In an embodiment, the low voltage ride-through module includes a power acquisition unit, a calculating unit and an instruction value configuration unit.

The power acquisition unit is configured to acquire the transmitted powers of the voltage source converter-high voltage direct current conversion station within a preset time period before the triggering low voltage ride-through.

The calculating unit is configured to calculate an average value of the transmitted powers of the voltage source converter-high voltage direct current conversion station within the preset time period.

The instruction value configuration unit is configured to determine the average value as the active power instruction value corresponding to the fault period.

In an embodiment, the apparatus further includes a power monitoring module and a dynamic regulation module.

The power monitoring module is configured to acquire the transmitted power of the voltage source converter-high voltage direct current conversion station in a real time manner during the low voltage ride-through.

The dynamic regulation module is configured to dynamically regulate the second integral coefficient based on the real-time value of the transmitted power of the voltage source converter-high voltage direct current conversion station during the low voltage ride-through.

In a third aspect, a storage medium is provided according to the present disclosure. The storage medium stores computer-readable instructions. The computer-readable instructions, when being executed by one or more processors, cause the one or more processors to perform the steps of the method for controlling voltage source converter-high voltage direct current fault ride-through in any one of the above embodiments.

In a fourth aspect, a computer device is provided according to the present disclosure, the computer device includes one or more processors, and a memory.

The memory stores computer-readable instructions. The one or more processors, when executing the computer-readable instructions, perform the steps of the method for controlling voltage source converter-high voltage direct current fault ride-through in any one of the above embodiments.

It can be seen from the above technical solutions, the embodiments of the present disclosure have the following advantages.

With the method and apparatus for controlling voltage source converter-high voltage direct current fault ride-through, the storage medium and computer device provided according to the present disclosure, an alternating-current side voltage of a conversion valve and a transmitted power of a voltage source converter-high voltage direct current conversion station are monitored. The low voltage ride-through is triggered in response to the alternating-current side voltage being less than a low voltage ride-through threshold. A second integral coefficient of the voltage outer-loop controller corresponding to the fault period is determined based on the difference between the active power instruction value corresponding to the fault period and the transmitted power, and the integral coefficient of the voltage outer-loop controller is switched to the second integral coefficient, thus reducing the integral coefficient of the voltage outer-loop controller. In a case that the real-time value of the alternating-current side voltage is greater than the low voltage ride-through threshold, the low voltage ride-through is ended and the fault recovery process is entered, and the integral coefficient of the voltage outer-loop controller is switched to the first integral coefficient before the fault. Therefore, the outer loop of the voltage source converter-high voltage direct current conversion station can maintain integral ability during the fault period, the current instruction value is prevented from changing rapidly and deviating excessively from the steady-state value due to the voltage deviation, thereby improving the transient stability of the system.

### BRIEF DESCRIPTION OF THE DRAWINGS

In order to more clearly describe technical solutions in the embodiments of the present disclosure or in the conventional technology, drawings to be used in the description of the embodiments or the conventional technology are briefly introduced hereinafter. It is apparent that the drawings described below show merely the embodiments of the present disclosure, and those skilled in the art may obtain other drawings based on the provided drawings without any creative effort.

FIG. 1 is a schematic diagram of an application scenario of a method for controlling voltage source converter-high voltage direct current fault ride-through according to an embodiment;

FIG. 2 is a flowchart of a method for controlling voltage source converter-high voltage direct current fault ride-through according to an embodiment;

FIG. 3 is a schematic diagram of a correlation between a difference between an active power instruction value and a transmitted power and a second integral coefficient according to an embodiment;

FIG. 4 is a schematic diagram of control logic of fault ride-through according to an embodiment;

FIG. 5 is a flowchart of steps for acquiring an active power instruction value corresponding to a fault period according to an embodiment;

FIG. 6 is a structural block diagram of an apparatus for controlling voltage source converter-high voltage direct current fault ride-through according to an embodiment; and

FIG. 7 is a schematic diagram of an internal structure of a computer device according to an embodiment.

### DETAILED DESCRIPTION OF THE EMBODIMENTS

The technical solutions in the embodiments of the present disclosure will be described clearly and completely hereinafter in conjunction with the accompanying drawings in the embodiments of the present disclosure. It is apparent that the described embodiments are only a part of the embodiments of the present disclosure and not all of the embodiments. Based on the embodiments of the present disclosure, all other embodiments obtained by those skilled in the art without any creative work fall into the protection scope of the present disclosure.

For an islanded transmission system, voltage source converter-high voltage direct current according to the conventional technology is generally implemented in a VF control manner, that is, a control phase is generated based on a given frequency. The d-axis and q-axis control branches are divided into the outer loop control and inner loop control. According to the conventional method for controlling voltage source converter-high voltage direct current fault ride-through, upon detecting a low voltage ride-through signal during the fault ride-through period, the outer-loop controller is frozen, and a current amplitude of the output current is limited according to the voltage drop, and then an equal proportional distribution is performed according to the d-axis current instruction value and q-axis current instruction value output from the outer loop to obtain the d-axis current instruction value and q-axis current instruction value with limited amplitudes. However, freezing the outer-loop controller causes that no power supply provided in the transmitting end system to regulate the voltage in a transient process, thereby leading to voltage instability when faults occurs in the transmitting end system. In a case that the fault is relatively severe, the excessively large deviation and excessively rapid action of the outer loop may cause problems in transient stability.

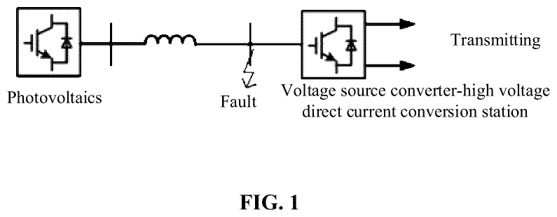

In view of the above problems, a method for controlling voltage source converter-high voltage direct current fault ride-through is provided according to embodiments of the present disclosure. The method is applied to a voltage source converter-high voltage direct current conversion station in a pure renewable energy islanded transmission system via voltage source converter-high voltage direct current. The pure renewable energy only includes renewable energy generator sets, such as only including photovoltaic power generations, or including photovoltaic power generations and wind power generations and the like. In an embodiment of the present disclosure, the scenario shown in FIG. 1 is taken as an example for illustrating, the photovoltaic power generation base performs impedance transmission over long lines, and perform power transmission via a voltage source converter-high voltage direct current converter. In a case that a three-phase ground fault occurs at a bus of a port of the voltage source converter-high voltage direct current converter, and the photovoltaic power generation base controls the fault ride-through using a power reduction control strategy.

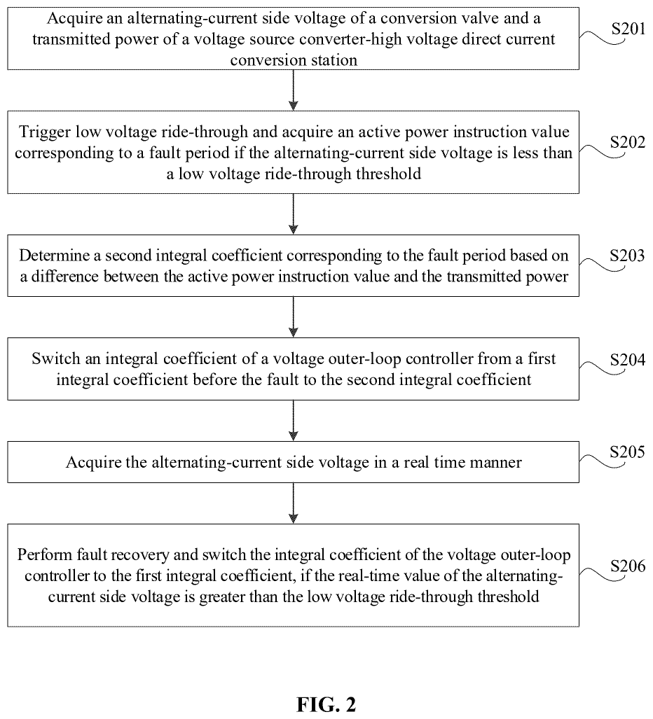

As shown in FIG. 2, a method for controlling voltage source converter-high voltage direct current fault ride-through is provided according to an embodiment of the present disclosure. The method includes the following steps S201 to S206.

In step S201, an alternating-current side voltage of a conversion valve and a transmitted power of the voltage source converter-high voltage direct current conversion station are acquired.

The conversion valve serves as a core device of a voltage source converter-high voltage direct current power transmission project, which is mainly formed by an IGBT, a control drive unit, a cooling system, a saturation reactor, a capacitor, a resistor and the like. Different from a thyristor, a semi-controlled device used in line commutated converter-high voltage direct current power transmission project, the conversion valve in the voltage source converter-high voltage direct current project generally adopts a fully-controlled device IGBT. The fully-controlled device IGBT is controlled to be turned on or off to implement conversion between alternating-current power and direct-current power. The alternating-current side voltage of the conversion valve and the transmitted power of the voltage source converter-high voltage direct current conversion station are measured by the detection device in a real time manner.

In step S202, low voltage ride-through is triggered and an active power instruction value

$${P}_{e}^{*}$$

corresponding to a fault period is acquired, if the alternating-current side voltage is less than a low voltage ride-through threshold.

The low voltage ride-through threshold is a preset voltage threshold used to determine whether the voltage source converter-high voltage direct current terminal to enter the low voltage ride-through process. The low voltage ride-through process is triggered and the active power instruction value

$${P}_{e}^{*}$$

corresponding to the fault period is acquired, if the alternating-current side voltage is less than the low voltage ride-through threshold.

In step S203, a second integral coefficient k_{iac2} corresponding to the fault period is determined based on the difference ΔPₑ between the active power instruction value

$${P}_{e}^{*}$$

and the transmitted power Pₑ.

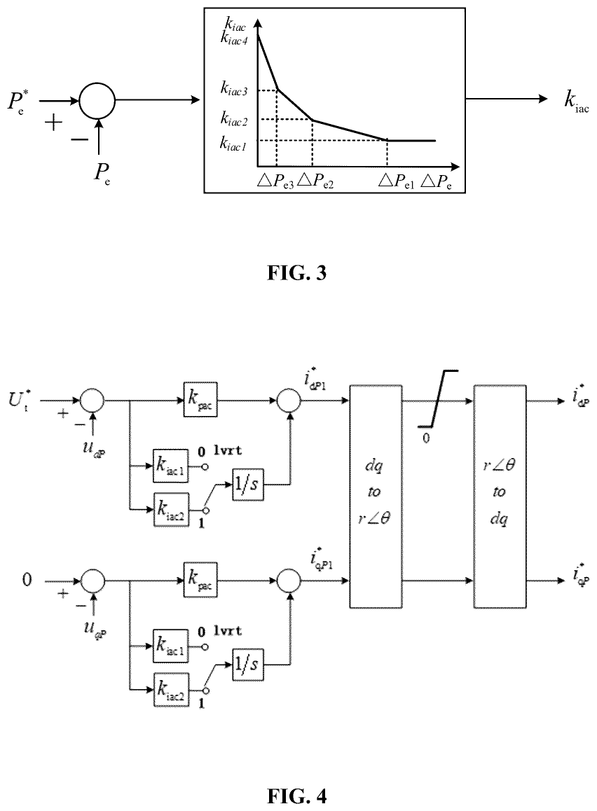

As shown in FIG. 3, the difference ΔPₑ between the active power instruction value

$${P}_{e}^{*}$$

corresponding to the fault period and the transmitted power P is negatively correlated with the second integral coefficient k_{iac2}. That is, when the ΔPₑ increases, the second integral coefficient k_{iac2} decreases.

In step S204, an integral coefficient of a voltage outer-loop controller is switched from a first integral coefficient k_{iac1} before the fault to the second integral coefficient k_{iac2}.

The first integral coefficient is greater than the second integral coefficient. The integral coefficient is switched to the second integral coefficient k_{iac2}, so as to reduce the integral coefficient of the voltage outer-loop controller, thereby reducing the change speed of the current instruction value affected by voltage deviation during the fault period.

In step S205, the alternating-current side voltage is acquired in a real time manner.

The alternating-current side voltage is acquired in a real time manner during the low voltage ride-through, so as to determine whether to end the low voltage ride-through and perform fault recovery.

In step S206, if the real-time value of the alternating-current side voltage is greater than the low voltage ride-through threshold, fault recovery is performed and the integral coefficient of the voltage outer-loop controller is switched to the first integral coefficient k_{iac1}.

Simultaneously when the fault recovery process is entered, the integral coefficient of the voltage outer loop controller is switched back to the first integral coefficient k_{iac1} before the fault.

Reference is made to FIG. 4, which shows control logic of fault ride-through according to an embodiment. Under a normal condition, lvrt=0, the integral coefficient of voltage outer-loop controller of the voltage source converter-high voltage direct current adopts the first integral coefficient k_{iac1}. In a case that the fault occurs, lvrt=1, the integral coefficient of the voltage outer-loop controller of the voltage source converter-high voltage direct current adopts the second integral coefficient k_{iac2}. Proportional integral control is performed on the outer loop voltage deviation to generate current instructions

$${i}_{dp 1}^{*} and {i}_{qp 1}^{*} ,$$

and the final current instructions

$${i}_{dp}^{*} and {i}_{qp}^{*}$$

are generated based on a proportional limit value.

In the embodiment, an alternating-current side voltage of a conversion valve and a transmitted power of the voltage source converter-high voltage direct current conversion station are monitored. The low voltage ride-through is triggered in response to the alternating-current side voltage being less than a low voltage ride-through threshold. A second integral coefficient k_{iac2} of the voltage outer-loop controller corresponding to the fault period is determined based on the difference between the active power instruction value corresponding to the fault period and the transmitted power, and the integral coefficient of the voltage outer-loop controller is switched to the second integral coefficient, thus reducing the integral coefficient of the voltage outer-loop controller. In a case that the real-time value of the alternating-current side voltage is greater than the low voltage ride-through threshold, the low voltage ride-through is ended and fault recovery process is entered, and the integral coefficient of the voltage outer-loop controller is switched to the first integral coefficient k_{iac1} before the fault. Therefore, the outer loop of the voltage source converter-high voltage direct current conversion station can maintain integral ability during the fault period, and the current instruction value is prevented from changing rapidly and deviating excessively from the steady-state value due to the voltage deviation, thereby improving the transient stability of the system.

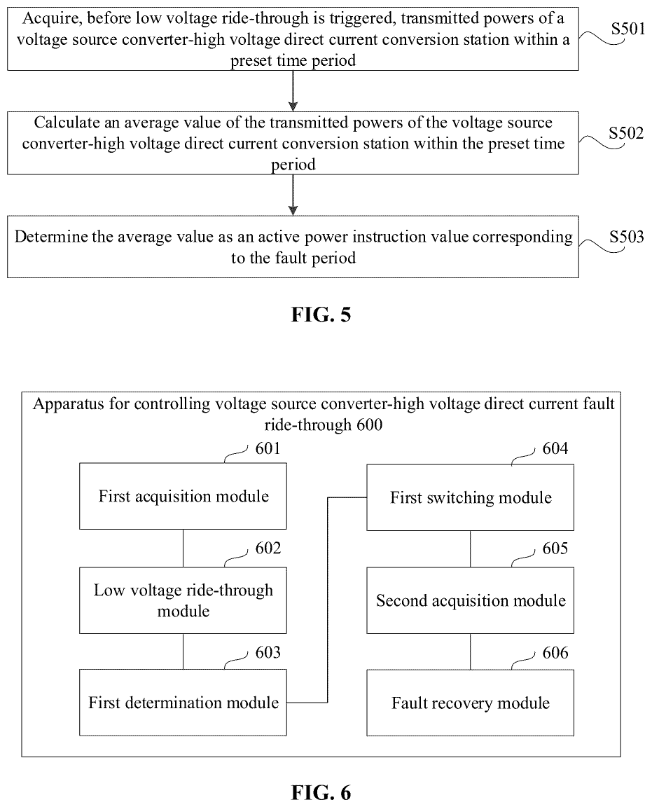

As shown in FIG. 5, in an embodiment, the acquiring an active power instruction value corresponding to a fault period includes the following steps S501 to S503.

In step S501, the transmitted powers of the voltage source converter-high voltage direct current conversion station within a preset time period before the triggering low voltage ride-through is acquired.

In step S502, an average value of the transmitted powers of the voltage source converter-high voltage direct current conversion station within the preset time period is calculated.

In step S503, the average value is determined as the active power instruction value corresponding to the fault period.

In the embodiment, the average value of the transmitted powers within the preset time period before triggering the low voltage ride-through is determined as the active power instruction value during the fault period. That is, a steady-state value before the fault is determined as a reference value. The average value is calculated to reduce the measurement errors during operation and the errors caused by normal fluctuations, so as to improve the system stability during the low voltage ride-through. In an embodiment, the preset time period is greater than or equal to 60 s.

In an embodiment, during the low voltage ride-through, the method for controlling voltage source converter-high voltage direct current fault ride-through further includes:
acquiring the transmitted power of the voltage source converter-high voltage direct current conversion station in a real time manner; and
dynamically regulating the second integral coefficient based on the real-time value of the transmitted power of the voltage source converter-high voltage direct current conversion station.

In the embodiment, if the transmitted power changes during the low voltage ride-through, the first integral coefficient is dynamically regulated. That is, the first integral coefficient is dynamically regulated based on the difference between the active power instruction value and the real-time value of the transmitted power.

In an embodiment, during the low voltage ride-through, after the determining a first integral coefficient based on a difference between the active power instruction value and the transmitted power, the method for controlling voltage source converter-high voltage direct current fault ride-through further includes:
calculating a second proportion coefficient kₚ₂ corresponding to the fault period based on the first integral coefficient k_{iac1}, the second integral coefficient k_{iac2} and a first proportion coefficient kₚ₁ of the voltage outer-loop controller before the fault; and
switching a proportion coefficient of the voltage outer-loop controller from the first proportion coefficient kₚ₁ to the second proportion coefficient kₚ₂, and switching the proportion coefficient to the first proportion coefficient kₚ₁ when the fault recovery is performed,
where the second proportion coefficient is calculated from the equation:

$${k}_{p 2} = {k}_{p 1} \sqrt{\frac{{k}_{iac 2}}{{k}_{iac 1}}} .$$

In the embodiment, during the low voltage ride-through, the integral coefficient and the proportion coefficient of the voltage outer-loop controller are regulated at the same time simultaneously. The proportion coefficient affects the extent of the change of current instruction value with respect to voltage deviation, so as to limit the current instruction value from deviating excessively from the steady state value. The proportion coefficient is switched to the first proportion coefficient before the fault when the fault recovery is performed.

It should be understood that, although steps in the flowcharts of the foregoing embodiments are depicted in a sequence indicated by arrows, it may be not necessary to execute the steps strictly according to such sequence indicated by arrows. Unless otherwise explicitly specified herein, a sequence of executing the steps is not strictly limited, and the steps may be implemented in another sequence. In addition, at least one step in these flowcharts of the above embodiments may include multiple sub-steps or multiple stages. It may be not necessary to execute the sub-steps or the stages simultaneously. Rather, the sub-steps or the stages may be executed at different time instants. Moreover, it may be not necessary to execute the sub-steps or the stages sequentially. Rather, the sub-steps or the stages may be implemented alternately or in rotation with at least some sub-steps or stages of another step.

The apparatus for controlling voltage source converter-high voltage direct current fault ride-through provided in the embodiments of the present disclosure is described below. The apparatus for controlling voltage source converter-high voltage direct current fault ride-through described below and the method for controlling voltage source converter-high voltage direct current fault ride-through described above may be referred to each other.

As shown in FIG. 6, an apparatus 600 for controlling voltage source converter-high voltage direct current fault ride-through is provided according to an embodiment of the present disclosure. The apparatus is applied to a voltage source converter-high voltage direct current conversion station in a pure renewable energy islanded transmission system via voltage source converter-high voltage direct current. The apparatus includes a first acquisition module 601, a low voltage ride-through module 602, a first determination module 603, a first switching module 604, a second acquisition module 605 and a fault recovery module 606.

The first acquisition module 601 is configured to acquire an alternating-current side voltage of a conversion valve and a transmitted power of the voltage source converter-high voltage direct current conversion station.

The low voltage ride-through module 602 is configured to trigger low voltage ride-through and acquire an active power instruction value corresponding to a fault period if the alternating-current side voltage is less than a low voltage ride-through threshold.

The first determination module 603 is configured to determine a second integral coefficient corresponding to the fault period based on a difference between the active power instruction value and the transmitted power.

The first switching module 604 is configured to switch an integral coefficient of a voltage outer-loop controller from a first integral coefficient before the fault to the second integral coefficient. The first integral coefficient is greater than the second integral coefficient, and the difference between the active power instruction value corresponding to the fault period and the transmitted power is negatively correlated with the second integral coefficient.

The second acquisition module 605 is configured to acquire the alternating-current side voltage in a real time manner.

The fault recovery module 606 is configured to perform fault recovery and switch the integral coefficient of the voltage outer-loop controller to the first integral coefficient, if the real-time value of the alternating-current side voltage is greater than the low voltage ride-through threshold.

In an embodiment, the low voltage ride-through module includes a power acquisition unit, a calculating unit and an instruction value configuration unit.

The power acquisition unit is configured to acquire the transmitted powers of the voltage source converter-high voltage direct current conversion station within a preset time period before the triggering low voltage ride-through.

The calculating unit is configured to calculate an average value of the transmitted powers of the voltage source converter-high voltage direct current conversion station within the preset time period.

The instruction value configuration unit is configured to determine the average value as the active power instruction value corresponding to the fault period.

In an embodiment, the apparatus further includes a power monitoring module and a dynamic regulation module.

The power monitoring module is configured to acquire the transmitted power of the voltage source converter-high voltage direct current conversion station in a real time manner during the low voltage ride-through.

The dynamic regulation module is configured to dynamically regulate the second integral coefficient based on the real-time value of the transmitted power of the voltage source converter-high voltage direct current conversion station during the low voltage ride-through.

In an embodiment, the apparatus further includes a second calculating module and a second switching module.

The second calculating module is configured to calculate, during the low voltage ride-through, a second proportion coefficient corresponding to the fault period based on the first integral coefficient, the second integral coefficient and a first proportion coefficient of the voltage outer-loop controller before the fault.

The second switching module is configured to switch a proportion coefficient of the voltage outer-loop controller from the first proportion coefficient to the second proportion coefficient, and switch the proportion coefficient back to the first proportion coefficient when the fault recovery is performed.

The division of the modules in the apparatus for controlling voltage source converter-high voltage direct current fault ride-through is only used for illustrative purposes. In other embodiments, the apparatus for controlling voltage source converter-high voltage direct current fault ride-through may be divided into different modules as required to implement all or part of the functions of the apparatus for controlling voltage source converter-high voltage direct current fault ride-through. The modules of the apparatus for controlling voltage source converter-high voltage direct current fault ride-through may be implemented, in whole or in part, by software, hardware and a combination of software and hardware. The foregoing module may be built in, or independent from, a processor in a computer device in a hardware form. Alternatively, the foregoing module may be stored in a memory in a computer device in a software form, so that a processor may invoke such module and perform an operation corresponding to such module.

In an embodiment, a storage medium is provided according to the present disclosure. The storage medium stores computer-readable instructions. The computer-readable instructions, when executed by one or more processors, cause the one or more processors to perform the following steps:
acquiring an alternating-current side voltage of a conversion valve and a transmitted power of the voltage source converter-high voltage direct current conversion station;
triggering low voltage ride-through and acquiring an active power instruction value corresponding to a fault period if the alternating-current side voltage is less than a low voltage ride-through threshold;
determining a second integral coefficient corresponding to the fault period based on a difference between the active power instruction value and the transmitted power;
switching an integral coefficient of a voltage outer-loop controller from a first integral coefficient before the fault to the second integral coefficient, where the first integral coefficient is greater than the second integral coefficient, and the difference between the active power instruction value corresponding to the fault period and the transmitted power is negatively correlated with the second integral coefficient;
acquiring the alternating-current side voltage in a real time manner; and
performing fault recovery and switching the integral coefficient of the voltage outer-loop controller to the first integral coefficient, if the real-time value of the alternating-current side voltage is greater than the low voltage ride-through threshold.

In an embodiment, the computer-readable instructions, when being executed by the processor, further cause the processor to perform the following steps:
acquiring the transmitted powers of the voltage source converter-high voltage direct current conversion station within a preset time period before the triggering low voltage ride-through;
calculating an average value of the transmitted powers of the voltage source converter-high voltage direct current conversion station within the preset time period; and
determining the average value as the active power instruction value corresponding to the fault period.

In an embodiment, the computer-readable instructions, when executed by the processor, further cause the processor to perform the following steps:
acquiring the transmitted power of the voltage source converter-high voltage direct current conversion station in a real time manner; and
dynamically regulating the second integral coefficient based on the real-time value of the transmitted power of the voltage source converter-high voltage direct current conversion station.

In an embodiment, the computer-readable instructions, when executed by the processor, further cause the processor to perform the following steps:
calculating a second proportion coefficient corresponding to the fault period based on the first integral coefficient, the second integral coefficient and a first proportion coefficient of the voltage outer-loop controller before the fault; and
switching a proportion coefficient of the voltage outer-loop controller from the first proportion coefficient to the second proportion coefficient, and switching the proportion coefficient to the first proportion coefficient when the fault recovery is performed.

In an embodiment, a computer device is provided according to the present disclosure. The computer device stores computer-readable instructions. The one or more processors, when executing the computer-readable instructions, performs the following steps:
acquiring an alternating-current side voltage of a conversion valve and a transmitted power of the voltage source converter-high voltage direct current conversion station;
triggering low voltage ride-through and acquiring an active power instruction value corresponding to a fault period if the alternating-current side voltage is less than a low voltage ride-through threshold;
determining a second integral coefficient corresponding to the fault period based on a difference between the active power instruction value and the transmitted power;
switching an integral coefficient of a voltage outer-loop controller from a first integral coefficient before the fault to the second integral coefficient, where the first integral coefficient is greater than the second integral coefficient, and the difference between the active power instruction value corresponding to the fault period and the transmitted power is negatively correlated with the second integral coefficient;
acquiring the alternating-current side voltage in a real time manner; and
performing fault recovery and switching the integral coefficient of the voltage outer-loop controller to the first integral coefficient, if the real-time value of the alternating-current side voltage is greater than the low voltage ride-through threshold.

In an embodiment, the one or more processors, when executing the computer-readable instructions, performs the following steps:
acquiring the transmitted powers of the voltage source converter-high voltage direct current conversion station within a preset time period before the triggering low voltage ride-through;
calculating an average value of the transmitted powers of the voltage source converter-high voltage direct current conversion station within the preset time period; and
determining the average value as the active power instruction value corresponding to the fault period.

In an embodiment, the one or more processors, when executing the computer-readable instructions, performs the following steps:
acquiring the transmitted power of the voltage source converter-high voltage direct current conversion station in a real time manner; and
dynamically regulating the second integral coefficient based on the real-time value of the transmitted power of the voltage source converter-high voltage direct current conversion station.

In an embodiment, the one or more processors, when executing the computer-readable instructions, performs the following steps:
calculating a second proportion coefficient corresponding to the fault period based on the first integral coefficient, the second integral coefficient and a first proportion coefficient of the voltage outer-loop controller before the fault; and
switching a proportion coefficient of the voltage outer-loop controller from the first proportion coefficient to the second proportion coefficient, and switching the proportion coefficient to the first proportion coefficient when the fault recovery is performed.

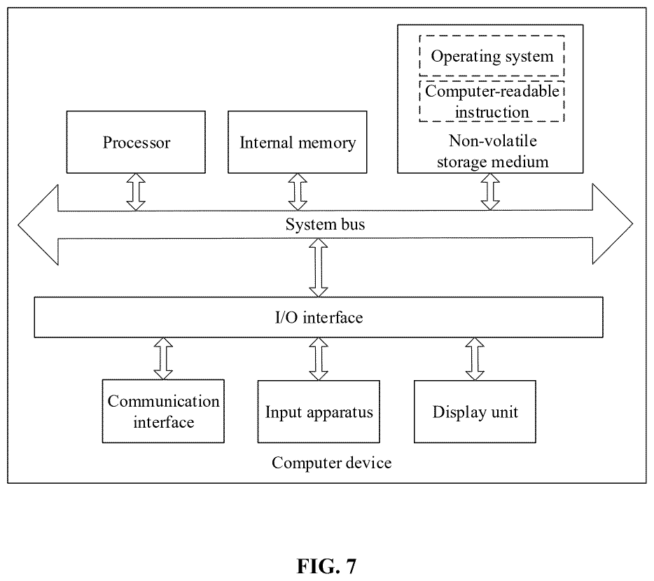

In an embodiment, a computer device is further provided. The computer device may be a terminal, and an internal structure of the terminal may be shown in FIG. 7. The computer device includes a processor, a memory, and a communication interface, a display screen, and an input apparatus that are connected via a system bus. The processor of the computer device is configured to provide computing and control functions. The memory of the computer device includes a non-volatile storage medium and an internal memory. The non-volatile storage medium stores an operating system and a computer program. The internal memory is configured to provide an environment for running the operating system and the computer program in the non-volatile storage medium. The communication interface of the computer device is configured to communicate with an external terminal in a wired or wireless manner. The wireless communication may be implemented through Wi-Fi, a mobile cellular network, near field communication (NFC), or other techniques. The computer program, when being executed by the processor, implements a method for controlling voltage source converter-high voltage direct current fault ride-through. The display screen of the computer device may be a liquid crystal display screen or an electronic ink display screen. An input apparatus of the computer device may be a touch control layer covering the display screen, may be a button, a trackball, or a touchpad disposed on housing of the computer device, and may be a keyboard, a touchpad, a mouse, or the like that is connected to the computer device.

Those skilled in the art should understand that, the structure shown in FIG. 7 is only a block diagram of a part of a structure correlated to the solutions according to the present disclosure and does not constitute a limitation to the computer device to which the solutions according to the present disclosure are applied. The computer device may include more components or fewer components than the components shown in the FIG. 7, or some components may be combined, or a different arrangement of components may be adopted.

Those skilled in the art can appreciated that all or some of procedures of the method in the foregoing embodiments may be implemented through a computer program instructing relevant hardware. The computer program may be stored in a non-volatile computer-readable storage medium. The procedures of the foregoing method embodiments may be implemented when the computer program is executed. Herein any reference to a memory, a database, or another medium in the embodiments provided according to the present disclosure may indicate at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory.

Illustratively not restrictively, the RAM may be implemented in multiple forms, such as a static random access memory (SRAM) or a dynamic random access memory (DRAM). Any database involved in the embodiments of the present disclosure may include at least one of a relational database and a non-relational database. The non-relational database may include but is not limited to a distributed database based on a blockchain, or the like. The processor involved in the embodiments of the present disclosure may include, but is not limited to, a general processor, a central processor, a graphics processor, a digital signal processor, a programmable logic device, a data processing logic device based on quantum computing, and the like.

Finally, it should also be noted that in the present disclosure, relational terms such as first and second are only used to distinguish one entity or operation from another, and do not necessarily require or imply that any such actual relationship or order exists in these entities or operations. Furthermore, the term “comprise”, “include” or any other variation thereof is intended to cover a non-exclusive inclusion, so that a process, a method, an article, or a device including a set of elements includes not only those elements, but also other elements not expressly listed or elements inherent in such a process, method, article, or device. Unless expressively limited, the element defined by the statement “including a . . . ” does not exclude the case that other similar elements may exist in the process, method, article or device including the series of elements.

In addition, the terms “first”, “second” and the like are for purpose of description, and should not be interpreted as indicating or implying relative importance or implying the number of the indicated technical features. Therefore, the features defined by “first” and “second” may explicitly or implicitly include at least one feature. In the description of the present disclosure, the term “multiple/plurality of” means at least two, such as two, or three, unless clearly defined otherwise.

The embodiments in this specification are described in a progressive manner, each of the embodiments emphasizes the differences from other embodiments, and the embodiments may be combined as needed, and the same or similar parts among the embodiments may be referred to each other.

According to the embodiments disclosed described above, those skilled in the art can implement or use the present disclosure. It is apparent for those skilled in the art to make many modifications to these embodiments. The general principle defined herein may be applied to other embodiments without departing from the spirit or scope of the present disclosure. Therefore, the present disclosure is not limited to the embodiments illustrated herein, but should be defined by the widest scope consistent with the principle and novel features disclosed herein.

1. A method for controlling voltage source converter-high voltage direct current fault ride-through, applied to a voltage source converter-high voltage direct current conversion station in a pure renewable energy islanded transmission system via voltage source converter-high voltage direct current, wherein the method comprises:
acquiring an alternating-current side voltage of a conversion valve and a transmitted power of the voltage source converter-high voltage direct current conversion station;
triggering low voltage ride-through and acquiring an active power instruction value corresponding to a fault period if the alternating-current side voltage is less than a low voltage ride-through threshold;
determining a second integral coefficient corresponding to the fault period based on a difference between the active power instruction value and the transmitted power;
switching an integral coefficient of a voltage outer-loop controller from a first integral coefficient before the fault to the second integral coefficient, wherein the first integral coefficient is greater than the second integral coefficient, and the difference between the active power instruction value corresponding to the fault period and the transmitted power is negatively correlated with the second integral coefficient;
acquiring the alternating-current side voltage in a real time manner; and
performing fault recovery and switching the integral coefficient of the voltage outer-loop controller to the first integral coefficient, if the real-time value of the alternating-current side voltage is greater than the low voltage ride-through threshold.

2. The method for controlling voltage source converter-high voltage direct current fault ride-through according to claim 1, wherein the acquiring an active power instruction value corresponding to a fault period comprises:
acquiring the transmitted powers of the voltage source converter-high voltage direct current conversion station within a preset time period before the triggering low voltage ride-through;
calculating an average value of the transmitted powers of the voltage source converter-high voltage direct current conversion station within the preset time period; and
determining the average value as the active power instruction value corresponding to the fault period.

3. The method for controlling voltage source converter-high voltage direct current fault ride-through according to claim 2, wherein the preset time period is greater than or equal to 60 s.

4. The method for controlling voltage source converter-high voltage direct current fault ride-through according to claim 1, wherein during the low voltage ride-through, the method further comprises:
acquiring the transmitted power of the voltage source converter-high voltage direct current conversion station in a real time manner; and
dynamically regulating the second integral coefficient based on the real-time value of the transmitted power of the voltage source converter-high voltage direct current conversion station.

5. The method for controlling voltage source converter-high voltage direct current fault ride-through according to claim 1, wherein during the low voltage ride-through, and after the determining a second integral coefficient based on a difference between the active power instruction value and the transmitted power, the method further comprises:
calculating a second proportion coefficient corresponding to the fault period based on the first integral coefficient, the second integral coefficient and a first proportion coefficient of the voltage outer-loop controller before the fault; and
switching a proportion coefficient of the voltage outer-loop controller from the first proportion coefficient to the second proportion coefficient, and switching the proportion coefficient to the first proportion coefficient when the fault recovery is implemented.

6. An apparatus for controlling voltage source converter-high voltage direct current fault ride-through, applied to a voltage source converter-high voltage direct current conversion station in a pure renewable energy islanded transmission system via voltage source converter-high voltage direct current, wherein the apparatus comprises:
a first acquisition module, configured to acquire an alternating-current side voltage of a conversion valve and a transmitted power of the voltage source converter-high voltage direct current conversion station;
a low voltage ride-through module, configured to trigger low voltage ride-through and acquire an active power instruction value corresponding to a fault period if the alternating-current side voltage is less than a low voltage ride-through threshold;
a first determination module, configured to determine a second integral coefficient corresponding to the fault period based on a difference between the active power instruction value and the transmitted power;
a first switching module, configured to switch an integral coefficient of a voltage outer-loop controller from a first integral coefficient before the fault to the second integral coefficient, wherein the first integral coefficient is greater than the second integral coefficient, and the difference between the active power instruction value corresponding to the fault period and the transmitted power is negatively correlated with the second integral coefficient;
a second acquisition module, configured to acquire the alternating-current side voltage in a real time manner; and
a fault recovery module, configured to perform fault recovery and switch the integral coefficient of the voltage outer-loop controller to the first integral coefficient, if the real-time value of the alternating-current side voltage is greater than the low voltage ride-through threshold.

7. The apparatus for controlling voltage source converter-high voltage direct current fault ride-through according to claim 6, wherein the low voltage ride-through module comprises:
a power acquisition unit, configured to acquire the transmitted powers of the voltage source converter-high voltage direct current conversion station within a preset time period before the triggering low voltage ride-through;
a calculating unit, configured to calculate an average value of the transmitted powers of the voltage source converter-high voltage direct current conversion station within the preset time period; and
an instruction value configuration unit, configured to determine the average value as the active power instruction value corresponding to the fault period.

8. The apparatus for controlling voltage source converter-high voltage direct current fault ride-through according to claim 6, further comprises:
a power monitoring module, configured to acquire the transmitted power of the voltage source converter-high voltage direct current conversion station in a real time manner during the low voltage ride-through; and
a dynamic regulation module, configured to dynamically regulate the second integral coefficient based on the real-time value of the transmitted power of the voltage source converter-high voltage direct current conversion station during the low voltage ride-through.

9. A storage medium, storing computer-readable instructions, wherein the computer-readable instructions, when being executed by one or more processors, cause the one or more processors to perform a method for controlling voltage source converter-high voltage direct current fault ride-through, wherein the method comprises:
acquiring an alternating-current side voltage of a conversion valve and a transmitted power of the voltage source converter-high voltage direct current conversion station;
triggering low voltage ride-through and acquiring an active power instruction value corresponding to a fault period if the alternating-current side voltage is less than a low voltage ride-through threshold;
determining a second integral coefficient corresponding to the fault period based on a difference between the active power instruction value and the transmitted power;
switching an integral coefficient of a voltage outer-loop controller from a first integral coefficient before the fault to the second integral coefficient, wherein the first integral coefficient is greater than the second integral coefficient, and the difference between the active power instruction value corresponding to the fault period and the transmitted power is negatively correlated with the second integral coefficient;
acquiring the alternating-current side voltage in a real time manner; and
performing fault recovery and switching the integral coefficient of the voltage outer-loop controller to the first integral coefficient, if the real-time value of the alternating-current side voltage is greater than the low voltage ride-through threshold.

10. A computer device, comprising one or more processors, and a memory; wherein
the memory stores computer-readable instructions, and the one or more processors, when executing the computer-readable instructions, performs the method for controlling voltage source converter-high voltage direct current fault ride-through according to claim 1.
